(19) United States
(12) Patent Application Publication
(10) Pub. No.: US 2026/0257625 A1
(43) Pub. Date: Sep. 3, 2026

(54) CAB STORAGE SYSTEM

(71) Applicant: Yoldas Askan, Birmingham (GB)

(72) Inventor: Yoldas Askan, Birmingham (GB)

(21) Appl. No.: 19/068,727

(22) Filed: Mar. 3, 2025

(51) Int. Cl. B60R 5/02; B60R 5/04; B60R 7/02; B60R 7/04; B60R 11/00

(52) U.S. Cl. CPC B60R 5/02; B60R 5/048; B60R 7/02; B60R 7/043; B60R 2011/0029; B60R 2011/0094

(57) ABSTRACT

A cab storage system which comprises a storage compartment positioned below the cab floor of a vehicle. The storage compartment is accessible by moving the cover between its open and closed configurations. The cover may be slidable or rotatable between its open and closed configurations. The storage compartment can store various items, including shoes, and may include a moisture-resistant lining, ventilation, and drainage. Additional features may include a heating element, lighting, and automatic opening mechanisms for convenience. A step may form the bottom of the storage compartment, and a door can serve as its sidewall. Covers can be flexible, rolling up when opened, or foldable, folding up when opened. This design maximizes storage efficiency, providing convenient and secure storage from inside of the vehicle, while maximizing unused space.

### BACKGROUND

### Field of the Invention

The present invention relates generally to storage compartments, and, in particular, to a cab storage system.

### Scope of the Prior Art

Storage compartments in vehicles are commonly used to provide additional space for storing personal items, tools, or emergency equipment. Many conventional designs use compartments within the dashboard, under seats, or in side panels of the vehicle's interior. While these designs offer storage solutions, they often utilize already occupied or easily cluttered areas, limiting storage capacity and accessibility.

### SUMMARY

The present invention is directed at a cab storage system. Positioned immediately below the cab floor, a storage compartment is accessible from the cab through a movable cover. The cover has a closed configuration in which the cover separates the storage compartment from the cab, and an open configuration, in which a driver can access the storage compartment through an opening to the storage compartment.

The cover may be slidably movable or rotatable around a hinge and can be integrated into either the cab floor or the vehicle door, depending on the design. In some embodiments, a locking mechanism secures the cover in its closed or open configurations. The compartment is designed to accommodate various items, including pairs of shoes, and may feature moisture-resistant lining, ventilation openings, or a drainage system to prevent water buildup and protect stored contents.

Additionally, the storage compartment may include a heating element to dry or warm items, lighting for visibility. An automatic opening mechanism may allow for hands-free operation. The bottom surface of the storage compartment may be formed by a step, while a door may serve as one of its sidewalls. In some configurations, the cover can be flexible, rolling up to open and unrolling to close, or foldable, folding up to open and unfolding to close.

### BRIEF DESCRIPTION OF THE DRAWINGS

The foregoing summary, as well as the following detailed description of preferred variations of the invention, will be better understood when read in conjunction with the appended drawings. For the purpose of illustrating the invention, there is shown in the drawings variations that are presently preferred. It should be understood, however, that the invention is not limited to the precise arrangements shown. In the drawings, where:

FIG. 1a shows a side view of a truck.

FIG. 1b shows a side view of a truck with the door removed.

FIG. 1c shows a front view of a truck.

FIG. 1d shows a cross-section view of the cab of a truck, as seen from the front.

FIG. 2a shows a storage compartment in a closed configuration, according to a first embodiment.

FIG. 2b shows the storage compartment in an open configuration.

FIG. 3a shows a storage compartment in a closed configuration, according to a second embodiment.

FIG. 3b shows the storage compartment in an open configuration.

FIG. 4a shows a storage compartment in a closed configuration, according to a third embodiment.

FIG. 4b shows the storage compartment in an open configuration.

FIG. 5a shows a storage compartment in a closed configuration, according to a fourth embodiment.

FIG. 5b shows the storage compartment in an open configuration.

FIG. 6a shows a storage compartment in a closed configuration, according to a fifth embodiment.

FIG. 6b shows the storage compartment in an open configuration.

FIG. 7a shows a storage compartment in a closed configuration, according to a fifth embodiment.

FIG. 7b shows the storage compartment in an open configuration.

FIG. 8a shows a side view of a truck cab with a storage compartment, according to an embodiment.

FIG. 8b shows a side view of a truck cab with a storage compartment, according to another embodiment.

### DETAILED DESCRIPTION

Implementations of the present technology will now be described in detail with reference to the drawings, which are provided as illustrative examples so as to enable those skilled in the art to practice the technology. Notably, the figures and examples below are not meant to limit the scope of the present disclosure to any single implementation or implementations. Wherever convenient, the same reference numbers will be used throughout the drawings to refer to same or like parts.

Moreover, while variations described herein are primarily discussed in the context of storage compartments in vehicles, it will be recognized by those of ordinary skill that the present disclosure is not so limited. In fact, the principles of the present disclosure described herein may be readily applied to storage compartments in general.

In the present specification, an implementation showing a singular component should not be considered limiting; rather, the disclosure is intended to encompass other implementations including a plurality of the same component, and vice-versa, unless explicitly stated otherwise herein. Further, the present disclosure encompasses present and future known equivalents to the components referred to herein by way of illustration.

It will be recognized that while certain aspects of the technology are described in terms of a specific sequence of steps of a method, these descriptions are only illustrative of the broader methods of the disclosure and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the disclosure disclosed and claimed herein.

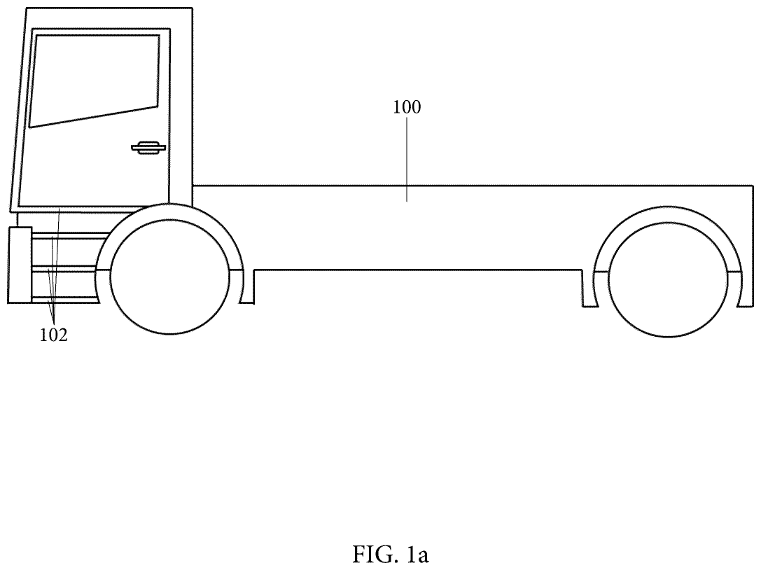

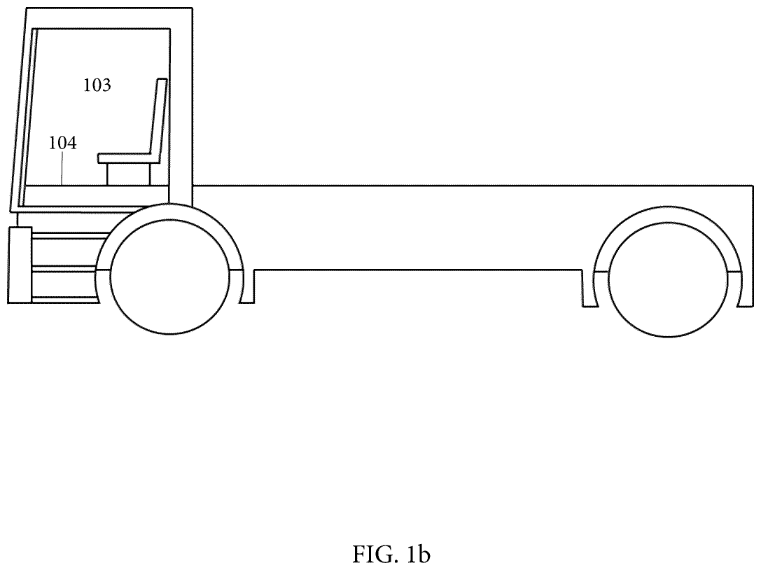

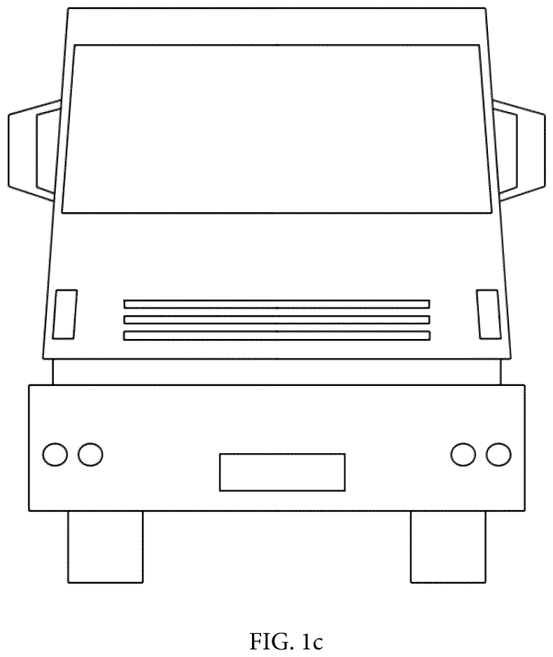

FIGS. 1a-1d show an exemplary truck 100. Steps 102 lead up to the cab 103. The cab floor 104 defines the bottom surface of the cab 103, where the cab floor 104 separates the interior space from the chassis and drivetrain components below.

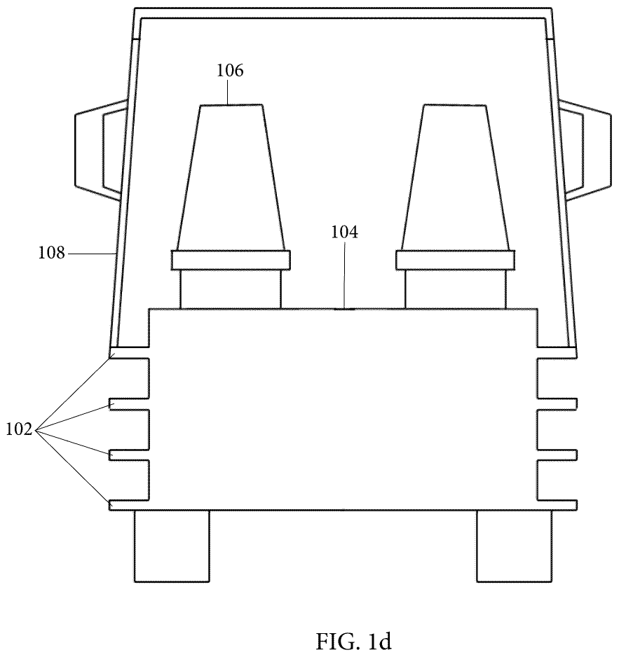

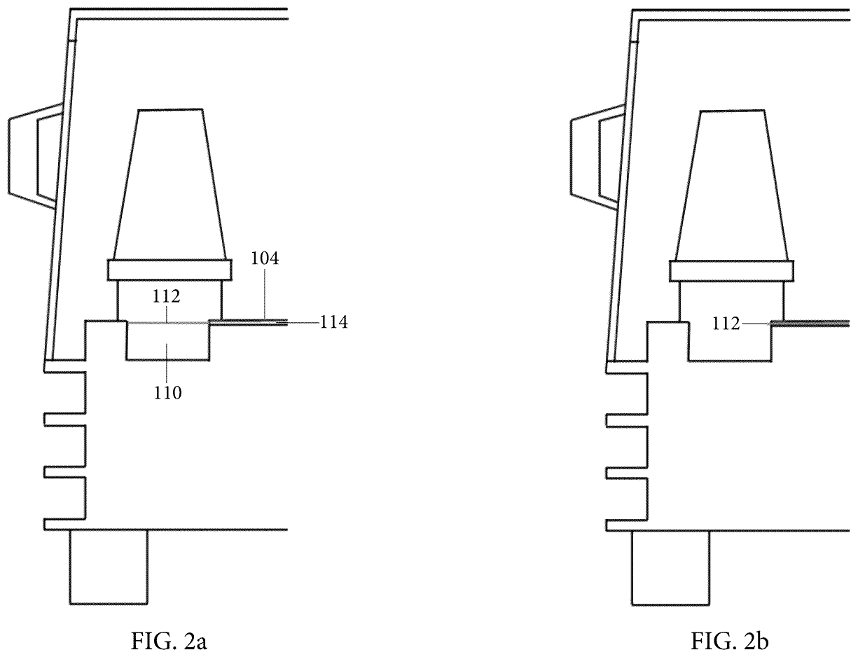

In FIGS. 2a-7b, only half of each cab 103 is shown for clarity purposes. The storage compartment 110 is positioned beneath the cab floor 104 such that the top of the storage compartment 110 is just below the cab floor 104. In the cover's closed configuration, the cover 112 is positioned over the an opening to the storage compartment 110, functioning as a barrier in between the storage compartment 110 and the inside of the cab 103. In the cover's open configuration, an opening to the storage compartment 110 is uncovered such that contents in the storage compartment 110 can be accessed from the cab 103.

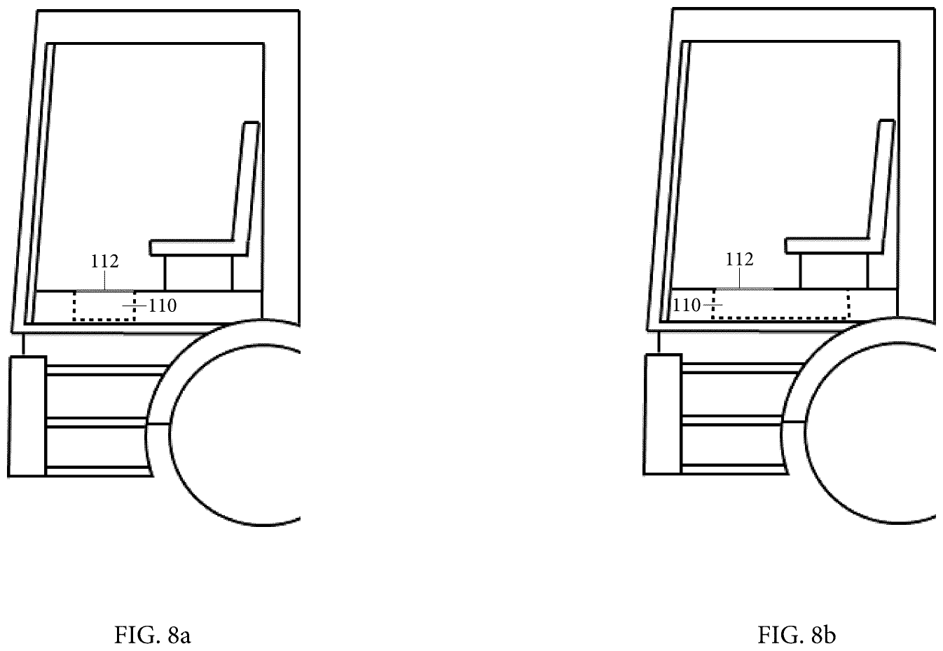

In an embodiment, such as shown in FIG. 8a, the storage compartment 110 and its opening are positioned in front of the driver's seat. Alternatively, the storage compartment 110 and its opening are positioned near the driver's seat. Yet alternatively, the storage compartment 110 and its opening are positioned near the passenger seat. Yet alternatively, the storage compartment 110 spans across multiple seats and its openings are positioned near multiple seats.

In an embodiment, the storage compartment 110 is a cuboid with rectangular faces. Alternatively, the storage compartment 110 can take on any three-dimensional shape.

In an embodiment, the storage compartment 110 is sized to accommodate a pair of shoes or another footwear. Alternatively, the bottom (e.g., the bottom face of the cuboid) of the storage compartment 110 is larger than its opening (e.g., the top face of the cuboid). For example, as shown in FIG. 8b, the opening to the storage compartment 110 is positioned in front of the driver's seat while the storage compartment 110 extends under the driver's seat. It should be appreciated that the storage compartment 110 can be sized to reach any area below the cab floor 104.

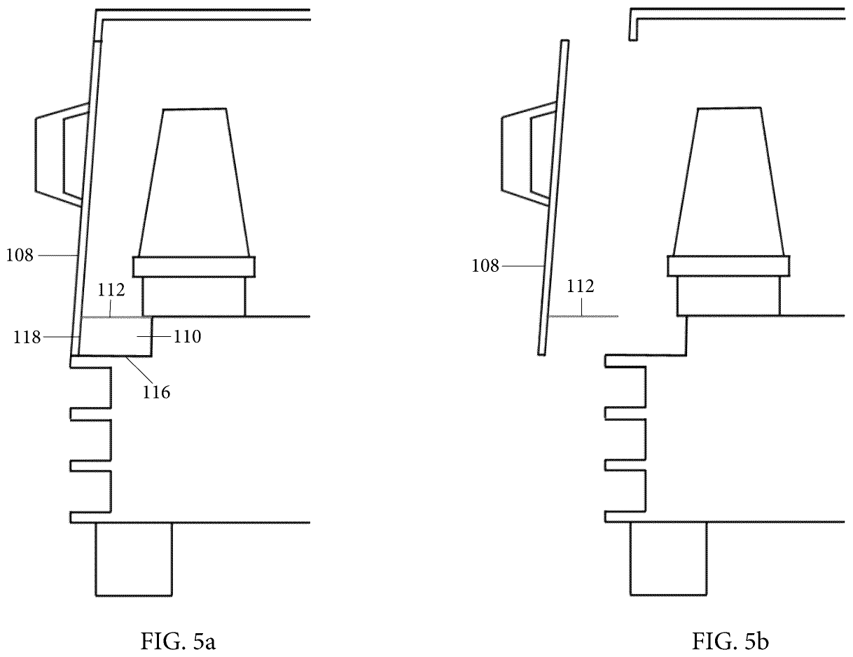

In an embodiment, the flat bottom face of the cuboid forms the bottom of the storage compartment 110, the vertical side faces of the cuboid form the sides of the storage compartment 110, and the flat top face of the cuboid forms the top of the storage compartment 110. A portion of the top of the storage compartment 110 acts as an opening to the storage compartment 110. Alternatively, as shown in FIG. 5a, for vehicles that require one or more steps to enter the cab 103 (e.g., semi-trucks), the top of the top step 116 forms the bottom of the storage compartment 110 or a portion thereof. For vehicles having a door 108 that extends below the cab floor 104, an inside 116 of the closed door forms one side of the storage compartment 110. Upon opening the door, as shown in FIG. 5b, the side of the storage compartment 110 is exposed, allowing access from both the inside of the cab and the exterior of the vehicle, depending on the door's orientation.

In an embodiment, the storage compartment 110 includes a moisture-resistant lining to protect the contents of the storage compartment 110. For example, a rubber lining.

In an embodiment, the storage compartment 110 and/or the cover 112 includes ventilation openings for airflow.

In an embodiment, the storage compartment 110 includes a drainage system 120 that redirects waste out of the vehicle (e.g., via a pipe from the bottom of the storage compartment 110 to below the vehicle), to an internal waste storage container (e.g. via a pipe from the bottom of the storage compartment 110 to a waste container located below the cab), and/or to a designated waste storage portion of the storage compartment 110 (e.g., the bottom of the storage compartment 110 is inclined such that liquids flow to one side of the storage compartment 110).

In an embodiment, the storage compartment 110 includes one or more heating element 122 (e.g., an electric heater) to dry and/or heat ant contents in the storage compartment 110.

In an embodiment, the storage compartment 110 includes one or more lighting elements 124 to illuminate contents of the storage compartment 110. The lighting elements 124 can automatically turn on when the storage compartment 110 is in its open configuration.

In an embodiment, the cover 112 separates the storage compartment 110 from the inside of the cab when the cover 112 is in its closed configuration.

In an embodiment, the top of the cover 112 is flush or generally flush with the cab floor 104 when the cover is in its closed configuration, such that the cover 112 substantially forms a portion of the cab floor 104 when the cover is in its closed configuration. Alternatively, the top of the cover 112 includes a handle or other types of grips. Yet alternatively, the top of the cover 112 includes padding or other types of foot rests.

In an embodiment, the cover 112 is rectangular or square. Alternatively, the cover 112 is shaped to cover the opening to the storage compartment 110.

In an embodiment, the cover 112 is integrated into the cab floor 104 and is slidably movable between its closed and open configurations. For example, as shown in FIGS. 2a-2b, the cover 112 can slide open, allowing the driver to access the storage compartment 110. It should be appreciated that the cover 112 is slidably movable in any direction.

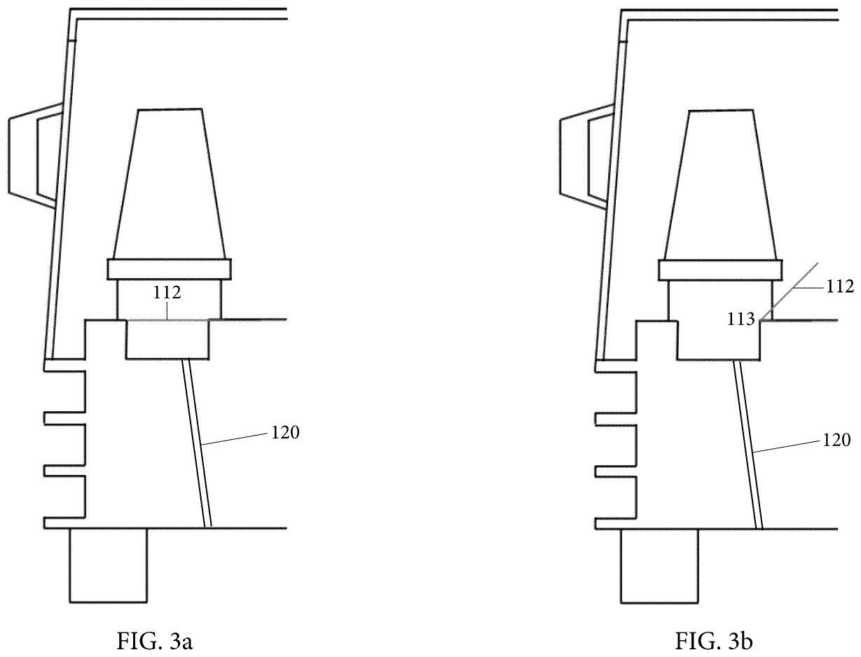

In an embodiment, the cover 112 is attached to the cab floor 104 via a hinge and is rotatable between its closed and open configurations. For example, as shown in FIGS. 3a-3b, the cover 112 is rotatable around the hinge 113, allowing the driver to access the storage compartment 110. It should be appreciated that the cover is rotatable along any horizontal or vertical axis.

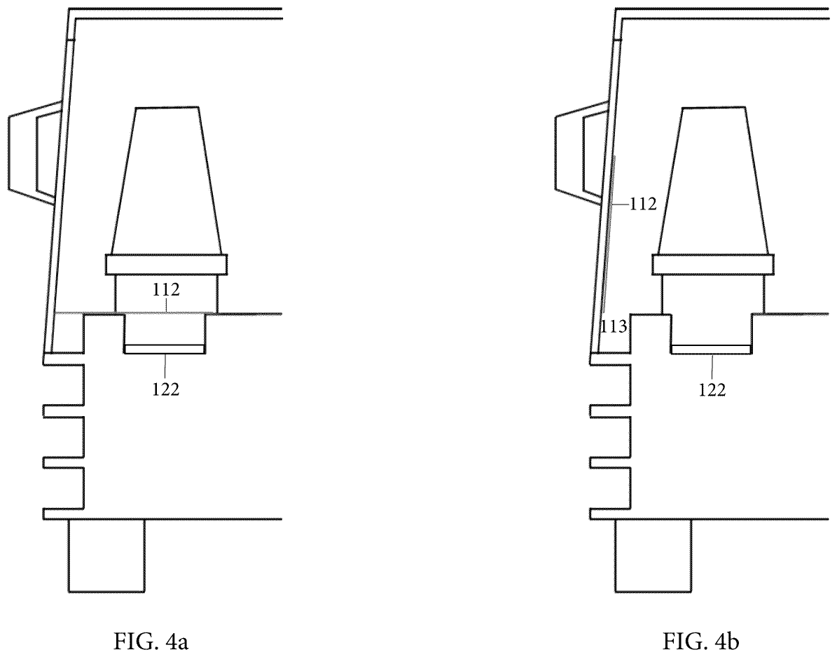

In an embodiment, the cover 112 is attached to the inside of the door 108 via a hinge and is rotatable between its closed and open configurations. For example, as shown in FIGS. 4a-4b, the cover 112 is rotatable around the hinge 113, allowing the driver to access the storage compartment 110. It should be appreciated that the cover 112 is rotatable along any horizontal or vertical axis.

In an embodiment, the cover 112 is integrated into the inside of the door 108 and is slidably movable between the storage compartment's closed and open configurations by opening and closing the door 108. For example, as shown in FIGS. 5a-5b, the cover slides 112 open, allowing the driver to access the storage compartment 110. It should be appreciated that the cover 112 is slidably movable in any horizonal direction.

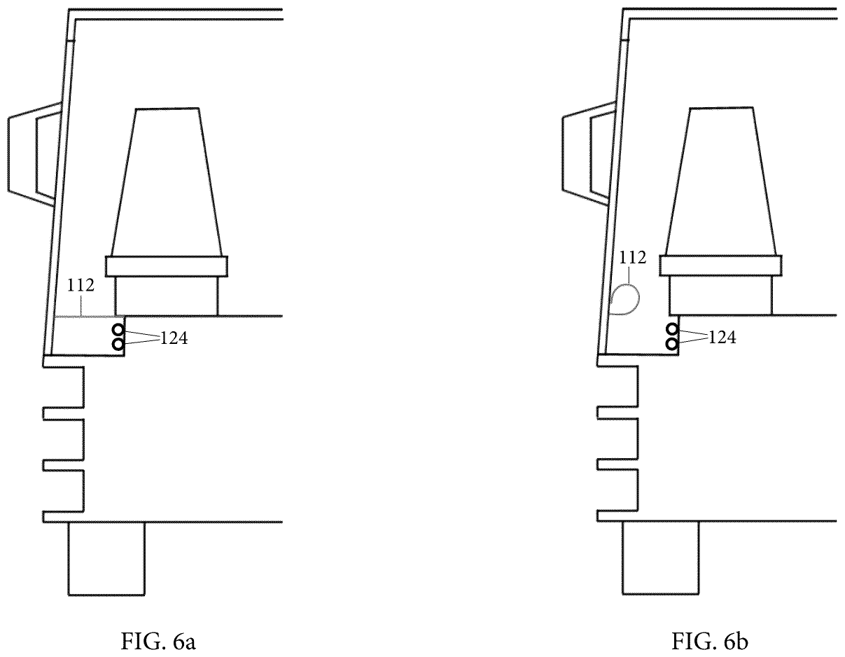

In an embodiment, the cover 112 is attached to the inside of the door 108 and is rollable between its closed and open configurations. For example, as shown in FIGS. 6a-6b, the cover 112 is flexible such that it can roll open, allowing the driver to access the storage compartment 110. It should be appreciated that the cover 112 is rollable in any direction.

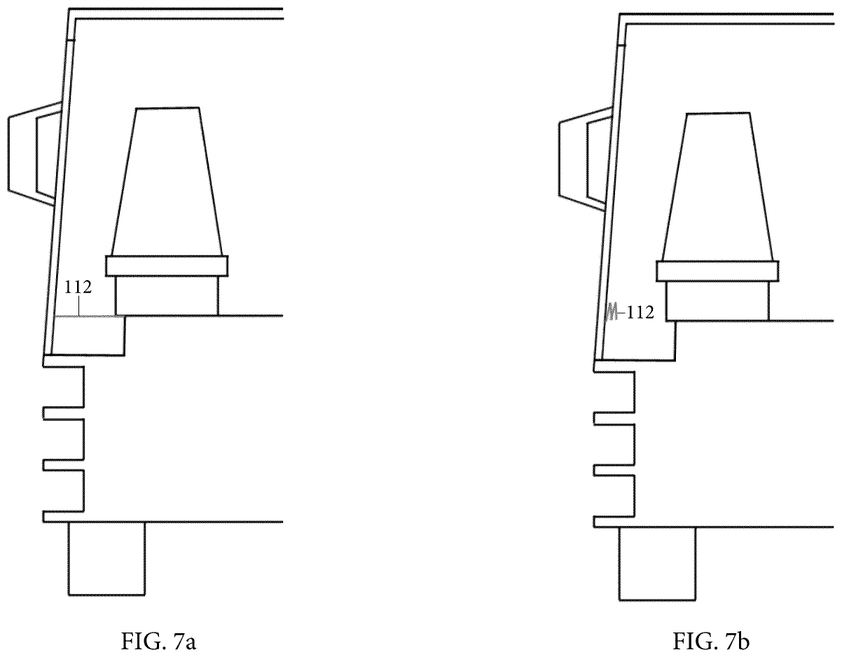

In an embodiment, the cover 112 is attached to the inside of the door 108 and is foldable between its closed and open configurations. For example, as shown in FIGS. 7a-7b, the cover 112 is made of segments such that it can fold up, allowing the driver to access the storage compartment 110. It should be appreciated that the cover 112 is foldable in any direction.

In an embodiment, the cover 112 can be secured in its closed and/or open configurations using one or more locking mechanisms (e.g., a latch lock or a friction fit lock) on the cover 112, the cab floor 104, and/or the door 108. Alternatively, the cover 112 can be secured in its closed and/or open configurations using sets of magnets embedded within the cover 112, the cab floor 104 and/or the door 108.

In an embodiment, the cover 112 is automatically moved between its configurations via an automatic opening mechanism. For example, pressing a button on the steering wheel or a sensor activates an electric motor which changes the cover's configuration. Alternatively, the cover 112 is moved via a spring-loaded opening mechanism. For example, tapping on the cover 112 activates the spring mechanism and opens the cover 112. Pressing down on the cover 112 resets the spring mechanism and closes the cover 112.

I claim:

1. A cab storage system, comprising:
a storage compartment positioned below a cab floor of a cab;
a cover, wherein
when the cover is in an open configuration:
an opening to the storage compartment is uncovered such that the storage compartment is accessible from the cab;
when the cover is in a closed configuration:
the cover is positioned over the opening to the storage compartment such that the cover separates the storage compartment from the cab.

2. The cab storage system of claim 1, wherein
the cover is positioned within the cab floor; and
the cover is slidably movable between the open and closed configurations.

3. The cab storage system of claim 1, wherein,
the cover is attached to the cab floor via a hinge; and
the cover is rotatable around the hinge the open and closed configurations.

4. The cab storage system of claim 1, wherein
the cover is attached to a door via a hinge; and
the cover is rotatable around the hinge the open and closed configurations.

5. The cab storage system of claim 1, further comprising
a locking mechanism integrated into the cover, the cab floor, or a door, wherein
the locking mechanism in configured to secure the cover in the closed configuration or in the open configuration.

6. The cab storage system of claim 1, wherein
the storage compartment is sized to accommodate a pairs of shoes.

7. The cab storage system of claim 1, further comprising:
a moisture-resistant lining within the storage compartment to protect contents placed in the storage compartment.

8. The cab storage system of claim 1, wherein
the cover includes ventilation openings for airflow.

9. The cab storage system of claim 1, wherein
the opening to the storage compartment is positioned near a driver's seat.

10. The cab storage system of claim 9, wherein
an inside of the storage compartment extends under the driver's seat.

11. The cab storage system of claim 1, wherein
a step forms a bottom of the storage compartment; and
a door forms a side of the storage compartment when the door is closed.

12. The cab storage system of claim 1, further comprising:
a drainage system that redirects waste from the storage compartment to at least one of:
an outside of a vehicle;
an internal waste storage container; and
a designated waste area in the storage compartment.

13. The cab storage system of claim 1, wherein
the cover is flexible; and
the cover rolls up into the open configuration unrolls into the closed configuration.

14. The cab storage system of claim 1, wherein
the cover comprises a plurality of foldable sections; and
the cover folds up into the open configuration and unfolds into the closed configuration.

15. The cab storage system of claim 1, further comprising:
a heating element to dry or heat contents placed in the storage compartment.

16. The cab storage system of claim 1, further comprising:
an automatic opening mechanism configurated to move the cover between the open and closed configurations.

17. The cab storage system of claim 1, further comprising:
a lighting element to illuminate contents placed in the storage compartment.

18. A cab storage system, comprising:
a storage compartment positioned below a cab floor of a cab, wherein
a step forms a bottom of the storage compartment;
a door forms a side of the storage compartment when the door is closed;
a cover, wherein
when the cover is in an open configuration:
an opening to the storage compartment is uncovered such that the storage compartment is accessible from the cab;
the opening to the storage compartment is positioned near a driver's seat;
when the cover is in a closed configuration:
the cover is positioned over the opening to the storage compartment such that the cover separates the storage compartment from the cab.

19. The cab storage system of claim 18, wherein
the cover is positioned within the cab floor; and
the cover is slidably movable between the open and closed configurations.

20. The cab storage system of claim 18, wherein,
the cover is attached to the cab floor via a hinge; and
the cover is rotatable around the hinge the open and closed configurations.
